(19) United States
(12) Patent Application Publication
(10) Pub. No.: US 2013/0082619 A1
(43) Pub. Date: Apr. 4, 2013

(54) CURRENT GENERATING CIRCUIT AND LED DRIVING CIRCUIT

(71) Applicant: Yu-En Lee, New Taipei City (TW)

(72) Inventor: Yu-En Lee, New Taipei City (TW)

(21) Appl. No.: 13/612,861

(22) Filed: Sep. 13, 2012

(30) Foreign Application Priority Data
Sep. 29, 2011 (TW) 100135208

(51) Int. Cl. H05B 37/02; H02M 7/25

(52) U.S. Cl. 315/224; 363/124

(57) ABSTRACT

A current generating circuit, for generating an output current to a target device, comprising: a current generating module; a grad power detecting circuit, for receiving a grad power signal and for generating a grad power detecting signal according to a voltage of the grad power signal; a feedback circuit, for generating a first feedback signal and a second feedback signal according to the output current; and a voltage converting controller, comprising a first input terminal and a second input terminal, wherein the first input terminal receives a grad power coupling signal generated by coupling the first feedback signal and the grad power detecting signal, and the second input terminal receives the second feedback signal, where the voltage converting controller controls the current generating module to generate the output current according to the grad power coupling signal and the second feedback signal.

### BACKGROUND OF THE INVENTION

1. Field of the Invention

The present invention relates to a current generating circuit and a LED (Light Emitting Diode) driving circuit, and particularly relates to a current generating circuit and a LED driving circuit with multi feedback paths.

2. Description of the Prior Art

FIG. 1A is a circuit diagram illustrating a prior art LED driving circuit 100. As shown in FIG. 1, a grad power providing device 120 includes a grad power source 122 and a rectifier 124, for generating a grad power signal PS. The LED driving circuit 100 receives the grad power signal PS, and accordingly generates a driving circuit I_{drive} to the LED 118. The LED driving circuit 100 always includes a voltage dividing circuit 102, which divides the voltage of the grad power signal PS and then provides it to the voltage converting controller 104. The voltage converting controller 104 decreases the voltage of the received voltage to control the switch device 108, and utilizes the conductor 110 to accordingly generate the driving circuit I_{drive}. Besides above-mentioned voltage dividing circuit 102, voltage converting controller 104 and switch device 108, the LED driving circuit 100 in FIG. 1 may includes other devices such as the diode 106, the capacitor 112 and resistors 114, 116 corresponding to different design. The operations of these devices are well known by persons skilled in the art, thus are omitted for brevity here.

However, in such structure, the driving circuit I_{drive} may be affected by variation of the grad power. For example, the current peak value for the current generated by the inductor 110 increases corresponding to rising of the grad power voltage level, since the current generated by the inductor 110 is highly dependent upon the grad power voltage level. Additionally, as shown in FIG. 1B, the period for charging the capacitor is positively relative to the grad power voltage level. Therefore the driving current I_{drive} may be out of control and highly increases, thereby the line regulation rate decreases.

In related fields, circuits with multi stages are provided to solve such problem. That is, more than one voltage converting controllers are utilized such that the variation of the grad power does not directly affect the driving current. However, such structure needs a large circuit region, and the increasing of devices also raises power consumption.

### SUMMARY OF THE INVENTION

Therefore, one objective of the present invention is to provide a current generating circuit, which can adjust the output current corresponding to variation of the grad power, without affecting power factor calibrating function.

Another objective of the present invention is to provide another LED driving circuit, which can adjust the output current corresponding to variation of the grad power.

One embodiment of the present invention discloses a current generating circuit, for generating an output current to a target device, comprising: a current generating module; a grad power detecting circuit, for receiving a grad power signal and for generating a grad power detecting signal according to a voltage of the grad power signal; a feedback circuit, for generating a first feedback signal and a second feedback signal according to the output current; and a voltage converting controller, comprising a first input terminal and a second input terminal, wherein the first input terminal receives a grad power coupling signal generated by coupling the first feedback signal and the grad power detecting signal, and the second input terminal receives the second feedback signal, where the voltage converting controller controls the current generating module to generate the output current according to the grad power coupling signal and the second feedback signal.

Another embodiment of the present invention discloses a LED driving circuit, for generating a driving current to a LED, comprising: a current generating module; a grad power detecting circuit, for receiving a grad power signal and for generating a grad power detecting signal according to a voltage of the grad power signal; a feedback circuit, for generating a first feedback signal and a second feedback signal according to the driving current; and a LED driver, comprising a first input terminal and a second input terminal, wherein the first input terminal receives a grad power coupling signal generated by coupling the first feedback signal and the grad power detecting signal, and the second input terminal receives the second feedback signal, where the LED driver controls the current generating module to generate the driving current according to the grad power coupling signal and the second feedback signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a circuit diagram illustrating a prior art LED driving circuit.

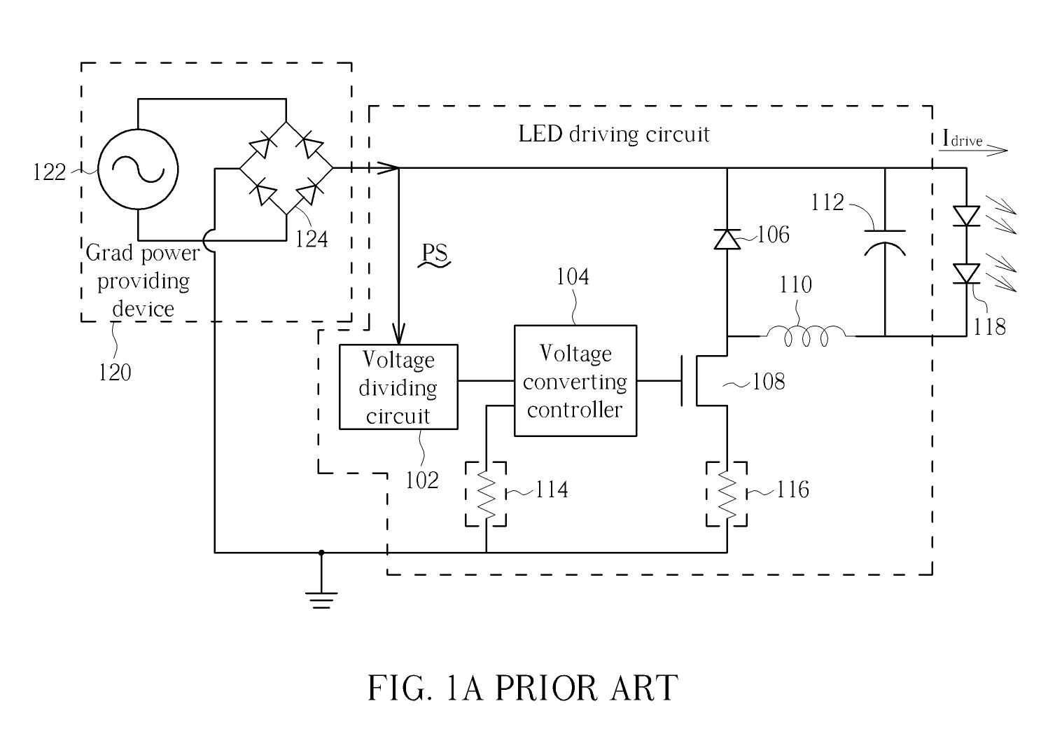

FIG. 1B is a schematic diagram illustrating relations between grid power voltage level and a period for charging an inductor.

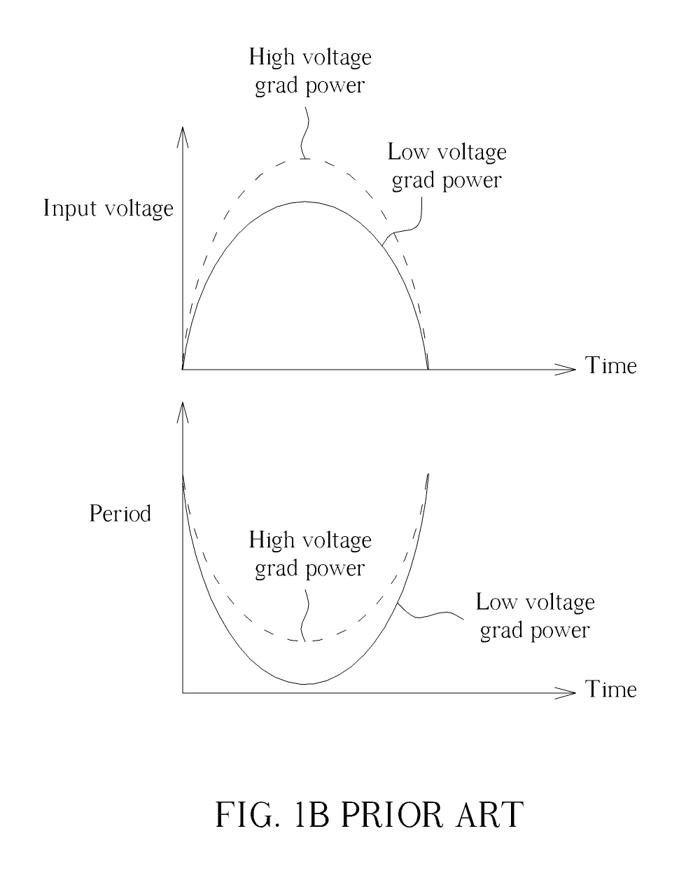

FIG. 2 is a block diagram illustrating a LED driving circuit according to one embodiment of the present invention.

FIG. 3 is one example for detail circuits of the block diagrams shown in FIG. 2.

FIG. 4 is one example for the voltage converting controller shown in FIG. 2 and FIG. 3.

FIG. 5 is an oscillogram for the signals in the LED driving circuit according to embodiments of the present application.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function.

In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

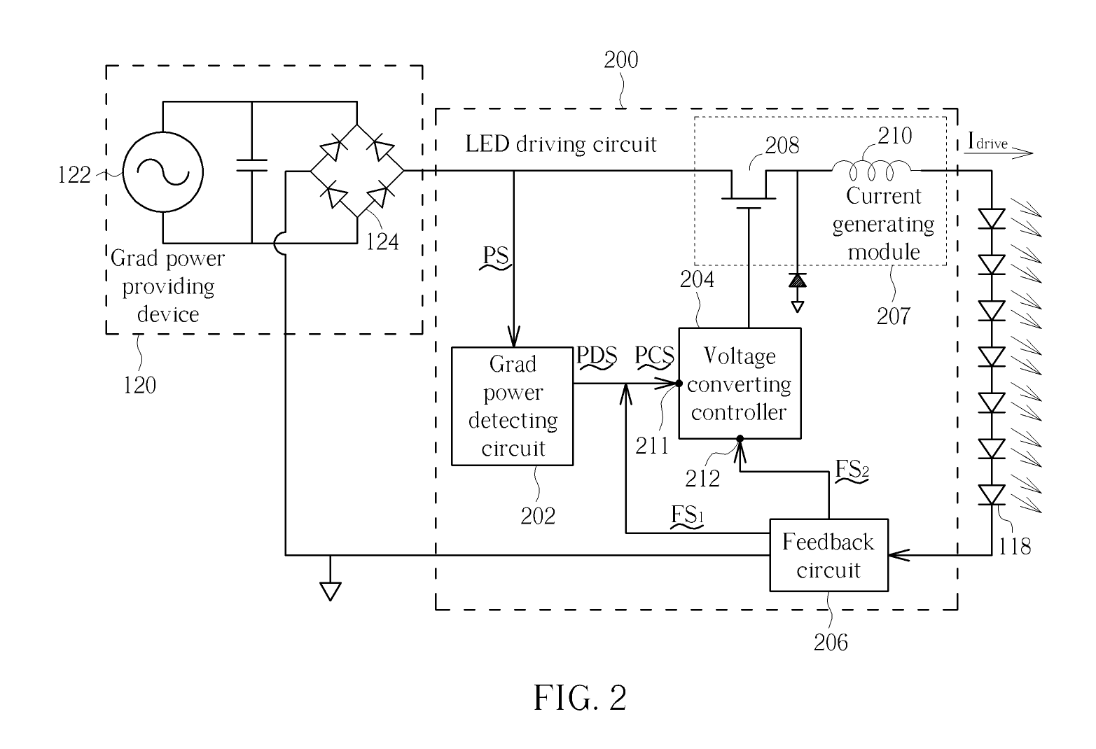

FIG. 2 is a block diagram illustrating a LED driving circuit 200 according to one embodiment of the present invention. As shown in FIG. 2, the LED driving circuit 200 also receives the grad power signal PS and accordingly generates the driving current I_{drive} to the LED 118. The LED driving circuit 200 includes: a grad power detecting circuit 202, a voltage converting controller 204, a feedback circuit 206 and a current generating module 207. The grad power detecting circuit 202 receives a grad power signal PS and generates a grad power detecting signal PDS according to a voltage of the grad power signal PS. In one embodiment, the grad power detecting circuit 202 detects a sin waveform of the grad power signal PS, and the grad power detecting signal PDS indicates the sin waveform of the grad power signal PS. The feedback circuit 206 generates a first feedback signal FS₁ and a second feedback signal FS₂ according to the driving current I_{drive}. In one embodiment, the feedback circuit 206 includes two feedback paths for respectively transmitting the first feedback signal FS₁ and the second feedback signal FS₂. The first feedback signal FS₁ and the grad power detecting signal PDS are coupled to form the grad power coupling signal PCS. The voltage converting controller 204 includes two input terminals 211, 212. The input terminal 211 receives the grad power coupling signal PCS and the input terminal 212 receives the feedback signal FS₂. Also, the voltage converting controller 204 controls the current generating module 207 to generate the driving current I_{drive} according to the grad power coupling signal PCS and the feedback signal FS₂. In one embodiment, the current generating module 207 includes a switch 208 and a conductor 210.

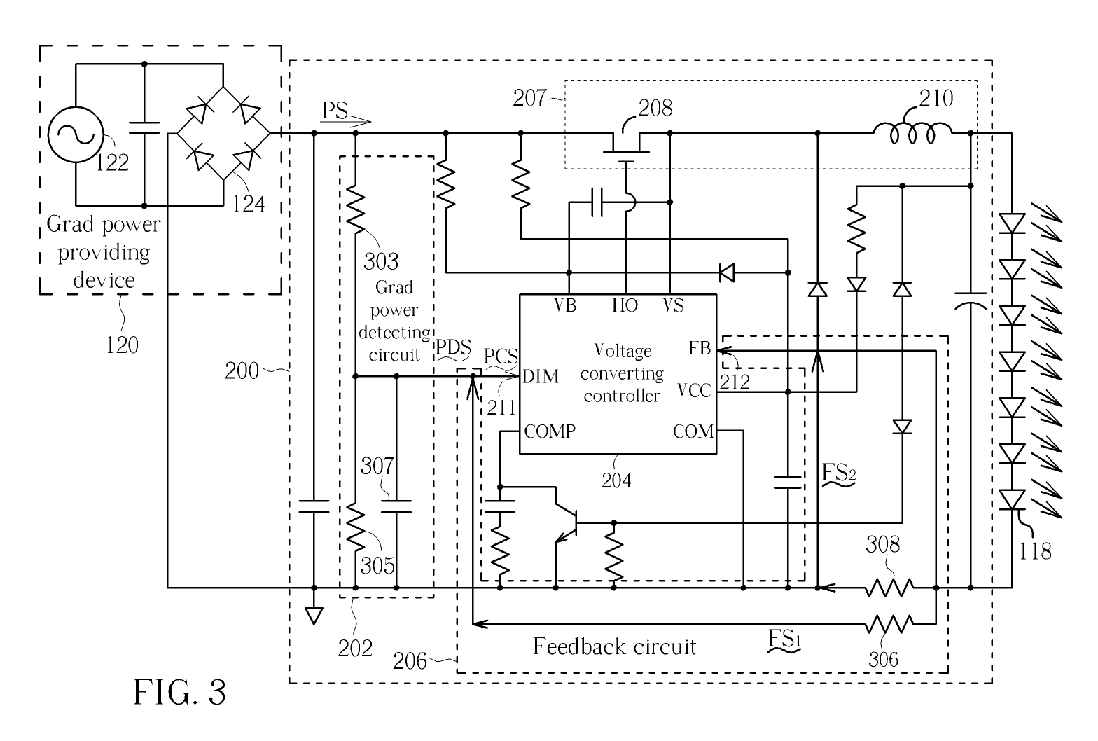

FIG. 3 is one example for detail circuits of the block diagrams shown in FIG. 2. As shown in FIG. 3, the feedback circuit 206 includes a resistor 306 and a resistor 308. The resistor 306 is coupled between the input terminal 211 and the output terminal 310 of the LED 118. The first feedback signal FS₁ is coupling to the grad power detecting signal PDS to form the grad power coupling signal PCS via the resistor 306 (one of the feedback paths) . The coupling ratio for the feedback signal FS₁ and the grad power detecting signal PDS can be determined by a value of the resistor 306. The resistor 308 is coupled between the input terminal 212 and the output terminal 310 of the LED 118. Moreover, the feedback signal FS₂ is transmitted to the input terminal 212 via the resistor 308 (another feedback path) . In this embodiment, the input terminal 211 is a DIM pin of the voltage converting controller, and the input terminal 212 is a FB pin of the voltage converting controller. In a normal voltage converting controller, the FB pin is utilized to receive a feedback current from a loading, and adjusts the driving current I_{drive} according to the feedback current. The DIM pin includes a comparator inside, which receives a sin waveform of the grad power signal and accordingly adjusts the driving current I_{drive}.

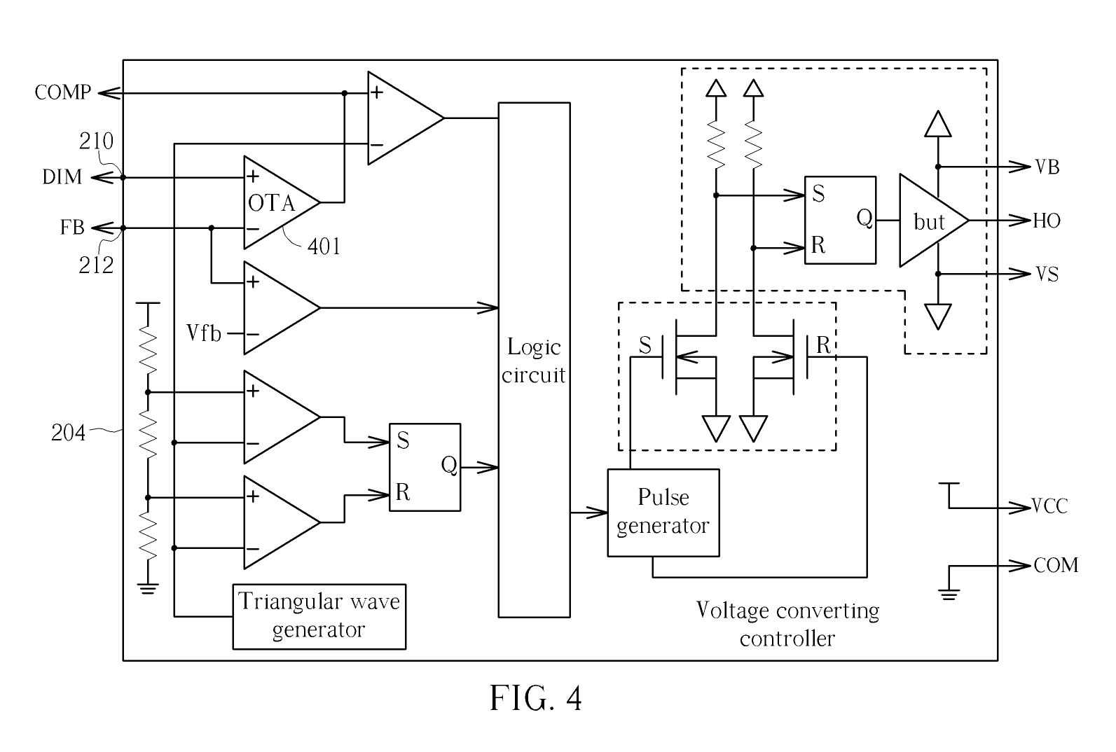

Please refer to FIG. 4, which is one example for the voltage converting controller shown in FIG. 2 and FIG. 3. Please note the voltage converting controller 204 is a LED driver in this embodiment. AS shown in FIG. 4, the voltage converting controller 204 includes a comparator 401, and the DIM pin, the FB pin are respectively two terminals of the comparator 401. Therefore the comparator 401 compares the feedback signal FS₂ and the grad power coupling signal PCS to adjust the driving current I_{drive}. The driving current I_{drive} is adjusted corresponding to the variation of the grad power, since the grad power coupling signal PCS includes waveform information of the grad power signal PS. Please note, besides the DIM pin and the FB pin, the voltage converting controller 204 in FIG. 3 and FIG. 4 further includes other pins such as the VB pin, the HO pin and the VS pin. Additionally, the LED driving circuit 200 shown in FIG. 3, and the voltage converting controller 204 in FIG. 4 also include devices besides above mentioned devices. The applicant holds these devices and pins are only for example and do not mean to limit the present invention. Persons skilled in the art can easily understand operations for these devices, thus it is omitted for brevity here. Additionally, the above-mentioned circuit structure is not limited to be applied for driving a LED, it can also be utilized to provide any desired output current to a target device besides the LED. In such case, the LED driving circuit 200 can be regarded as a current generating circuit.

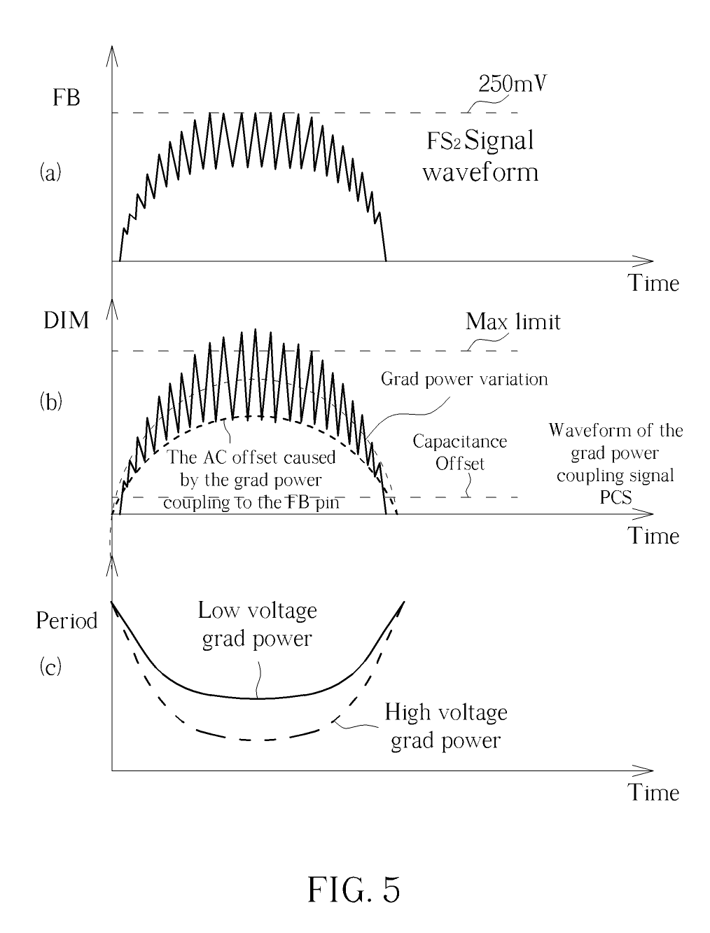

FIG. 5 is an oscillogram for the signals in the LED driving circuit according to embodiments of the present application. As shown in FIG. 5 (a), the feedback signal FS₂ is a serration wave, which is coupling to the grad power detecting signal PDS to generate a waveform shown in FIG. 5 (b). AS shown in FIG. 5 (b), Max Limit is a maximum limit voltage (250 mv in this example) for the IC, and the capacitance offset is the offset caused by capacitance inside the IC. Additionally, the AC offset is the offset caused by the grad power coupling signal PCS to the FB pin. If the grad power has a higher voltage level, the AC offset is larger, thus the waveform moves up, such that the portion of the serration part cut by Max Limit increases. Also, as shown in FIG. 5 (c), if the grad power has a higher voltage level, the period for charging the conductor decreases rather than increases as depicted in the prior art. Accordingly, the LED current can be suppressed.

As above-mentioned description, the present invention can adjust the LED driving current corresponding to variation of the grad power without utilizing multi stage circuits. By this way, the issue that the LED driving current varies following the variation of grad power is solved via utilizing only one stage circuit. Therefore, the issue of large circuit region and higher power consumption due to multi stage circuits.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A current generating circuit, for generating an output current to a target device, comprising:
a current generating module;
a grad power detecting circuit, for receiving a grad power signal and for generating a grad power detecting signal according to a voltage of the grad power signal;
a feedback circuit, for generating a first feedback signal and a second feedback signal according to the output current; and
a voltage converting controller, comprising a first input terminal and a second input terminal, wherein the first input terminal receives a grad power coupling signal generated by coupling the first feedback signal and the grad power detecting signal, and the second input terminal receives the second feedback signal, where the voltage converting controller controls the current generating module to generate the output current according to the grad power coupling signal and the second feedback signal.

2. The current generating circuit of claim 1, wherein the grad power detecting circuit comprises:
a first resistor, coupled between the grad power signal and the first input terminal;
a second resistor, coupled between the first input terminal and a output terminal of the target device; and
a capacitor, coupled between the first input terminal and the output terminal of the target device.

3. The current generating circuit of claim 1, wherein the feedback circuit comprises:
a first resistor, coupled between the first input terminal and a output terminal of the target device, wherein the first feedback signal is coupling to the grad power detecting signal via the first resistor; and
a second resistor, coupled between the first input terminal and the output terminal of the target device, wherein the second feedback signal is transmitted to the second input terminal via the second resistor.

4. The current generating circuit of claim 3, wherein a coupling ratio for the first feedback signal and the grad power detecting signal is determined by a value of the first resistor.

5. The current generating circuit of claim 1, wherein the voltage converting controller includes a comparator, the first input terminal and the second terminal are two input terminals of the comparator, where the comparator compares the grad power coupling signal and the second feedback signal to generate a comparing result and the voltage converting controller generates the output current according to the comparing result.

6. The current generating circuit of claim 1, wherein the feedback circuit comprises:
a first feedback path, for transmitting the first feedback signal to the voltage converting controller; and
a second feedback path, for transmitting the second feedback signal to the voltage converting controller.

7. A LED driving circuit, for generating a driving current to a LED, comprising:
a current generating module;
a grad power detecting circuit, for receiving a grad power signal and for generating a grad power detecting signal according to a voltage of the grad power signal;
a feedback circuit, for generating a first feedback signal and a second feedback signal according to the driving current; and
a LED driver, comprising a first input terminal and a second input terminal, wherein the first input terminal receives a grad power coupling signal generated by coupling the first feedback signal and the grad power detecting signal, and the second input terminal receives the second feedback signal, where the LED driver controls the current generating module to generate the driving current according to the grad power coupling signal and the second feedback signal.

8. The LED driving circuit of claim 7, wherein the grad power detecting circuit comprises:
a first resistor, coupled between the grad power signal and the first input terminal;
a second resistor, coupled between the first input terminal and a output terminal of the LED; and
a capacitor, coupled between the first input terminal and the output terminal of the LED.

9. The LED driving circuit of claim 7, wherein the feedback circuit comprises:
a first resistor, coupled between the first input terminal and a output terminal of the LED, wherein the first feedback signal is coupling to the grad power detecting signal via the first resistor; and
a second resistor, coupled between the first input terminal and the output terminal of the LED, wherein the second feedback signal is transmitted to the second input terminal via the second resistor.

10. The LED driving circuit of claim 9, wherein a coupling ratio for the first feedback signal and the grad power detecting signal is determined by a value of the first resistor.

11. The LED driving circuit of claim 7, wherein the LED driver includes a comparator, the first input terminal and the second terminal are two input terminals of the comparator, where the comparator compares the grad power coupling signal and the second feedback signal to generate a comparing result and the LED driver generates the driving current according to the comparing result.

12. The LED driving circuit of claim 7, wherein the feedback circuit comprises:
a first feedback path, for transmitting the first feedback signal to the LED driver; and
a second feedback path, for transmitting the second feedback signal to the LED driver.
